(19) United States
(12) Patent Application Publication
(10) Pub. No.: US 2021/0207570 A1
(43) Pub. Date: Jul. 8, 2021

(54) WAVE ENERGY HARVESTER WITH THREE DEGREES OF FREEDOM

(71) Applicant: Leviathan Energy L.L.C., Lawrence, NY (US)

(72) Inventors: Mark Daniel Farb, Beit Shemesh (IL); Anurag Purwar, Stony Brook, NY (US); Banu Sajja, Hicksville, NY (US)

(21) Appl. No.: 17/183,371

(22) Filed: Feb. 24, 2021

Related U.S. Application Data
(63) Continuation-in-part of application No. 16/643,565, filed on Mar. 1, 2020, now abandoned.

(30) Foreign Application Priority Data
Sep. 3, 2017 (US) 62553851

(51) Int. Cl. F03B 13/20

(52) U.S. Cl. CPC F03B 13/20; F05B 2250/43; F05B 2250/23

(57) ABSTRACT

Irregular motion of waves creates a challenge to obtain energy efficiently. Heave type devices have been found to have high efficiencies, but they are limited to capturing energy along one or two directions of freedom. A new system and method for obtaining energy from the heaving motion of the waves is presented. It consists of base and heave structures connected through arm devices comprising three degrees of freedom, said arms powered by the motion of the heave structure in the fluid. These arm devices allow capture of wave energy by mechanical, hydraulic, or pneumatic systems.

### CROSS REFERENCE TO RELATED APPLICATIONS

This patent application is the continuation in part of U.S. patent application Ser. No. 16/643,565 and claims the benefit of U.S. Provisional Patent Application No. 62/553,851, entitled Wave Energy Harvester with 3 Points of Freedom, filed Sep. 3, 2017.

### BACKGROUND OF THE INVENTION

The present invention relates to a new concept for obtaining energy from ocean waves. It involves at least 2, preferably 3, attaching devices called arm devices, between 2 structures, one of which is anchored and one of which—typically called a heave structure—is moved by the waves. Providing 3 arm devices, comprising 3 joints and 2 arms between 2 structures, is the ideal configuration.

Definitions: A revolute joint is also called a rotational joint. A prismatic joint is also called a sliding joint. An arm is the tubular structure attached on each side to a joint. An arm device refers to the combination of 2 arms and 3 joints. The 3 joints provide 3 degrees of movement freedom—that is, 3 joints at which movement can occur.

There are several categories of invention for obtaining energy from ocean waves. One of the most efficient types has been the heave variety, one of which is known as Salter's duck, shown in FIG. 4.

The present application is in the heave category of wave energy converters. So it is worthwhile to understand how the classic heave converter, Salter's Duck, works. The following quotation is from https://science.howstuffworks.com/environemtnal/green-science/salters-duck1.htm “Salter's Duck is just one of many concepts for a wave energy converter (WEC), which can potentially convert wave power to usable energy . . . . The Duck itself is shaped like a teardrop, and many of these “teardrops” attach to a long spine to make up the whole Salter's system. The nose of the teardrop faces incoming waves and bobs as they pass. Essentially, this involves a transfer, or “capture,” of the wave's energy. In theory, this bobbing action would capture as much as 90 percent of the wave's massive energy, and uses that energy to keep pistons running. The pistons in turn pressurize hydraulic oil. When pressurized enough, the oil enters a hydraulic motor, which generates electricity [source: Stuart]. The system would theoretically use 90 percent of the captured energy. This high efficiency makes the Duck the Holy Grail of WECs.”

This application has a novel method for addressing one of the deficiencies of that standard: that it has poor adaptation to changes in wave height. Since wave energy is proportional to the height squared, the inability to extend beyond a limited range is a deficiency in efficiency that becomes more glaring the greater the variation in wave height.

The Salter duck transduces the wave energy by using 4 gyroscopes that move with the wave motion and create hydraulic energy. Salter showed in U.S. Pat. No. 4,300,871 how the gyroscopes work. The gyroscopes are arranged in pairs to get energy from opposite directions of movement. Each gyroscope drives a hydraulic pump which then drives a hydraulic circuit which then drives an electric generator. FIGS. 1-3 of U.S. Pat. No. 4,300,871 show how it works. The claims state this clearly.

Another patent by Salter, U.S. Pat. No. 3,928,967, states, “In order to convert the pivotal motion of the wave removing member into useable energy, a pump such as a variable stroke rotary pump having a stator fixed relative to the supporting member and having a rotor which turns with the energy removing member can be provided. In such pumps. hydraulic bearings can be utilized.”

Gyroscopic power conversion is known.

A related device is the category of oscillating wave surge converter. These devices typically have one end connected to a structure or the seabed while the other end is free to move. The arm oscillates as an inverted pendulum mounted on a pivoted joint in response to the movement of water in the waves. Energy is collected from the relative motion of the body with respect to the connected point. FIG. 5 shows an example in the Oyster wave converter. It operates as a single degree of freedom device. It only takes advantage of the vertical motion of the wave.

Surface attenuators operate to some extent by heave. Attenuator devices are relatively long in length (up to 150 m) as compared to ocean wavelengths, and are typically positioned in parallel to the general direction of wave propagation. Attenuators consist of multiple buoyant segments that articulate as wave crests and troughs pass. Mechanical energy is extracted from the relative motion of each segment, usually though the compression of a fluid in hydraulic pistons. Attenuators can be designed to float freely and operate at the water's surface or can be arranged to articulate in reaction to a connected structure attached to the ocean floor. The most notable surface attenuator WEC is the Pelamis. These systems are very inefficient.

Another example of a heave structure is U.S. Pat. No. 9,169,823 B2. It is a device for generating electricity that includes a buoyant structure, a heave plate, at least one load carrying structure that is mechanically coupled to both the buoyant structure and the heave plate, and at least one magnetostrictive element. The magnetostrictive element is configured to experience force changes applied by the load carrying structure caused by hydrodynamic forces acting on the device. It is shown in FIG. 6. This device, in comparison to the current invention, lacks joints, and lacks three degrees of freedom.

WEC U.S. Pat. No. 9,169,823 B2—The device uses a floating buoyant structure which is attached to a heaving plate by magnetostrictive elements and load carrying elements. The floating structure has 3 points of connection to the heaving plate. The device has a cylindrical buoy as floating structure. The device uses a heave plate in order to damp the heave response of the body.

The force changes in the load carrying structures between the heave plate and the float create current flow in the magnetostrictive elements.

Current Application—We use a floating structure which is attached to a base plate using mechanical linkages such as sliding or rolling joints. The floating structure has 3 points of connection to the base plate. We use any appropriate shape as a floating element. We connect the base plate either by using a pile attached to the seabed or by using mooring lines. The movement of the hydraulic pistons due to the relative movement of the float with respect to the base plate creates pressurized fluid which can be used to produce power, but we are not limited to that way of generating power.

U.S. Pat. No. 4,631,921 describes, as shown in FIG. 7, a float for supporting a submerged wave energy harvesting device that includes a conical member which is buoyant on the surface of the body of water. The conical member rocks or otherwise moves in response to wave motion on the surface of the body of water. An electrical generator is located within the interior of the conical member and is connected to the device. Supplemental positioning floats each connected to an anchor can be positioned in a geometrical configuration around the conical member with a tether connected between the conical member and each of the supplemental floats to maintain both the conical member and the device in a fixed position with respect to the ocean floor.

WEC 4,631,921 The device has a conical floating structure which is attached to a generator via a shaft. The conical structure has 3 points of connection to the floatation system.

The device has a conical buoy as floating structure. The device uses hydraulic turbines to generate power.

Our Device—We use a floating structure which is attached to a base plate using mechanical linkages such as prismatic or rolling joints. The floating structure has 3 points of connection to the base plate. We use a triangular structure as a floating element. We use hydraulic pistons to pump hydraulic fluid into turbine.

Current technologies utilize either one or two degrees of freedom of the wave in order to harvest the energy. A device having three degrees of freedom in a connected plane is the ideal way to harness energy for heave, surge, and pitch, as the device can adjust and orient itself according to the wave characteristics. In this device, there a moving platform connected to a base (or, fixed) platform via three arm devices (or, kinematic chain) each of single degree of freedom consisting of a trio of revolute, “R”, (rotational) or prismatic, “P”, (sliding) joints. Consequently each of the independent kinematic chains can be denoted by a set of three letters indicating the succession of joints starting from the ground. A revolute joint (also called pin joint or hinge joint) is a one-degree-of-freedom kinematic pair used in mechanisms. Revolute joints provide single-axis rotation function used in many places such as door hinges, folding mechanisms, and other uni-axial rotation devices. A prismatic joint provides a linear sliding movement between two bodies, and is often called a slider, as in the slider-crank linkage. A prismatic joint can be formed with a polygonal cross-section to resist rotation. For example, if a serial chain is PRR, there is a prismatic joint at A and there are two revolute joints at B and C (joint connected to the moving platform) respectively, in FIG. 8. The possible combinations of Revolute (R) and Prismatic (P) joints in a PPM are RRR, RRP, RPR, RPP, PRR, PRP, PPR. The PPP chain is not useful and must be excluded because only two planar P joints in a chain are independent, and hence it only translates with no change in orientation. Hence, there are seven possible useful kinematic chains. See FIG. 9. Power produced by the moving platform is equal to the sum of all the individual powers produced at each of the actuated joints.

It was found by simulation that the best position of the device is for the heave structure to be immersed into the water such that the incoming wave height completely submerges its top surface.

The invention can be customized to the prevailing wave situation in each area in the process of design for a particular area according to the area's wave height, as the flow chart in FIG. 10 shows. (WEC=Wave Energy Converter. AQWA is a software package.)

### BRIEF SUMMARY OF THE INVENTION

The present invention successfully addresses the shortcomings of the presently known configurations by providing a 3-points-of-freedom device to obtain energy from waves. The energy is transformed into useful form through hydraulics or circular motion in most cases.

It is now disclosed for the first time a system for obtaining energy from a wave in a body of water, comprising:

a base structure, with at least two sides, fixed to a base in or adjacent to waves,

a floating heave structure, with at least two sides, said heave structure substantially submerged by the water,

at least two arm devices, each arm device comprising:
a base joint of either a prismatic P type or a revolute R type attached to a side of the base structure facing the heave structure,
a heave joint of either the prismatic P type or the revolute R type attached to a side of the heave structure facing the base structure, said heave joint corresponding substantially to positions of the base joints on the base structure,
each said base joint is substantially aligned vertically with each said heave joint, said alignment termed to constitute a pair,
each base joint is attached to a base arm,
each heave joint is attached to a heave arm,
each vertically aligned pair of base and heave arms with their respective joints is attached to a middle joint of either the prismatic P or revolute R types;
each said arm device may be arranged in the following joint sequences, wherein the base joint is mentioned first as R for resolute or P for prismatic, the middle joint is mentioned second, and the heave joint is mentioned third: RRR, RRP, RPP, PRR, PRP, PPR,
each said arm device is connected to at least one generator system, said generator system defined as any mechanism, such as hydraulic or electrical, that results in energy production from the motion of the arm device,
each system comprises exactly 3 arm devices,
at least one joint is connected to a generating system, optionally a gyroscope, a hydraulic take off device, or a device including bevel gears for creating unidirectional motion attached to a generator.

In one embodiment, the system further comprises at least one said generator system comprises a hydraulic mechanism containing a compressible fluid, said fluid compressed by the motion of the arms and joints.

In one embodiment, the system further comprises at least one arm device comprises an electric generator, operating from rotational motion of any of the arm's revolute joints.

In one embodiment, the base structure is below the heave structure.

In one embodiment, the base structure is between an upper part of the wave on the surface and a lower part of the wave, beneath the surface.

In one embodiment, the base structure is adjustable in height above a sea floor of the body of water while fixed to a supporting object.

In one embodiment, a second heave structure is attached by said three arm devices to a second side of the base structure.

In one embodiment, the heave structure is substantially planar.

In one embodiment, the heave structure is a polygonal structure

In one embodiment, at least one part of the heave structure is concavely cupped in an area of impact of the wave on the heave structure,

In one embodiment, a length of the heave structure is equal to or a little greater than a wavelength of the wave.

In one embodiment, the heave structure is at least partially hollow.

It is disclosed for the first time a method for constructing a system to harvest energy from a wave in a body of water, comprising:
providing a base structure, with at least two sides, fixed to a base in or adjacent to waves,
providing a floating heave structure, with at least two sides,
providing at least two arm devices, each arm device comprising:
   a base joint of either a prismatic or a revolute type attached to a side of the base structure facing the heave structure,
   a heave joint of either the prismatic P type or the revolute R type attached to a side of the heave structure facing the base structure, said heave joint corresponding substantially vertically to a position of the base joint on the base structure, said alignment termed to constitute a pair,
each said base joint is attached to a base arm,
each said heave joint is attached to a heave arm,
each vertically aligned pair of base and heave arms and their respective joints is attached to a middle joint;
each arm device is connected to at least one generator system, said generator system defined as any mechanism, such as hydraulic or electrical, that results in energy production, from the motion of the arm device,
at least one joint is connected to a generating system, optionally a gyroscope, a hydraulic take off device, or a device including bevel gears for creating unidirectional motion attached to a generator.

In one embodiment, it comprises at least 3 arm devices.

In one embodiment, during an initial construction of the system in the process of project design, it further comprises the steps of:

obtaining data comprising height of waves in a particular location over time,
determining a standard wave height, based on one of a group of average, median, or mode of the wave heights in a designated area,
setting the fully extended height of the arm devices for said location as at least double the standard wave height.

### BRIEF DESCRIPTION OF SEVERAL VIEWS OF THE DRAWINGS

The invention is herein described, by way of example only, with reference to the accompanying drawings, wherein:

FIG. 1 is a diagram of 3 three-degree-of-freedom arm devices attached to base and heave structures.

FIG. 2 is a diagram of a platform with straight hydraulic connections.

FIG. 3 is a diagram of surfaces of a concave heave structure.

FIGS. 4-7 illustrate prior art.

FIG. 8 is a diagram of prismatic and revolute joints.

FIG. 9 is a diagram of different possible movements of a three-degree-of-freedom device.

FIG. 10 is an outline of the method of evaluating a site for a three-degree-of-freedom device.

FIG. 11 is a diagram of several devices operating with different maximal and minimal wave height.

FIG. 12 is a figure of prior art bevel gear and clutch.

FIG. 13 is a figure of prior art rack and pinion system with bevel gears.

FIG. 14 is a schematic figure showing how a shaft moving back and forth pushes on hydraulic fluid.

FIG. 15 shows how a piston can be attached to a prismatic joint.

### DETAILED DESCRIPTION OF THE INVENTION

The principles and operation of a wave energy converter according to the present invention may be better understood with reference to the drawings and the accompanying description.

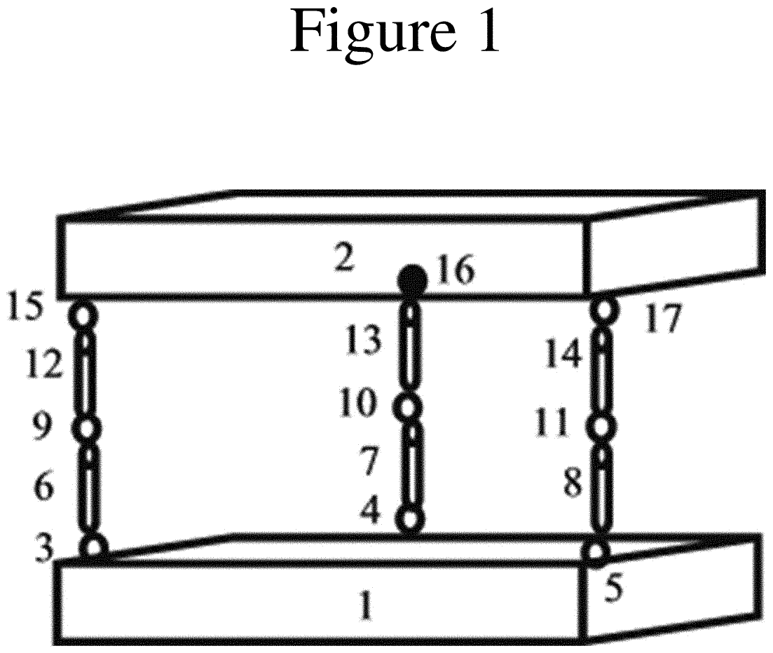

Referring now to the drawings, FIG. 1 illustrates a three-degree-of-freedom device. (1) is the base structure and (2) is the heave structure. Joints attached to the base structure are (3,4,5). Joints attached to the heave structure are (15,16,17). Note that (16) is really not seen from this perspective. The joints on the base structure are ideally substantially aligned vertically with the joints on the heave structure. This enables optimal freedom of the three arm devices as a group. Each base joint is attached to an arm (6,7,8). Each heave joint is attached to an arm (12,13,14). The base and heave arms meet in a middle joint (9,10,11). An example of an arm device would be (3,6,9,12,15). Three arm sets provide limitations in 3 dimensions over the motion of the heave structure. A heave joint is the joint adjacent to the heave structure; a base joint is the joint adjacent to the base structure.

A base structure does not necessarily have to be below the heave structure.

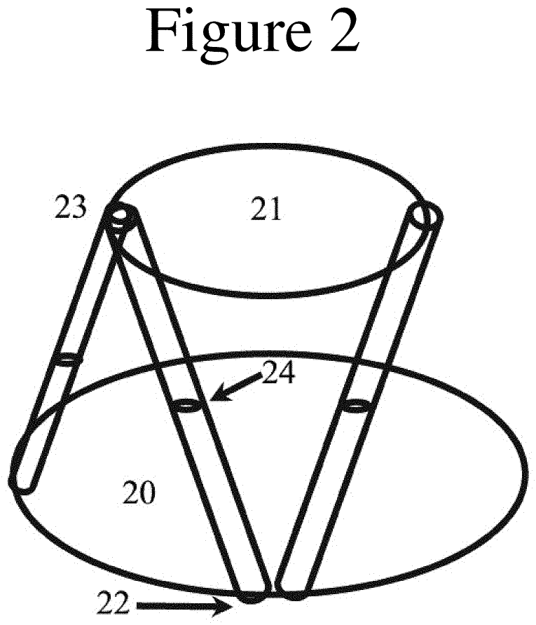

FIG. 2 shows an example of a three-degree-of-freedom device with more arms than are necessary for the current invention, since the figure, for the sake of clarity, shows only 3 of the 6 arms. This is a Stewart's platform, which is made for robotics controls, otherwise an example of the current invention's configuration, except for the facts that it is made for movement under human control, not for absorption of energy from a rolling wave, and thereby consumes rather than produces energy, and that for the current application, three arm devices are adequate. More than 3 are unnecessary. (20) is the base structure and (21) is the upper platform, or what would be termed in this invention, a heave structure. It is also different from the current application as all its joints are the RPR type but constrained in their motion because they do not attach to a similar vertical location on the base and heave structures so they are not fully free. (22) is the base joint, (23) is the heave joint, and (24) is the middle joint, connecting two arms. The middle joint (24) is an example of a prismatic or sliding joint. A Stewart platform is limited to such a RPR joint. To our knowledge, no one has utilized the concept of the control available from robotics configurations to use them backwards to enable waves to drive a harvesting of mechanical or hydraulic energy.

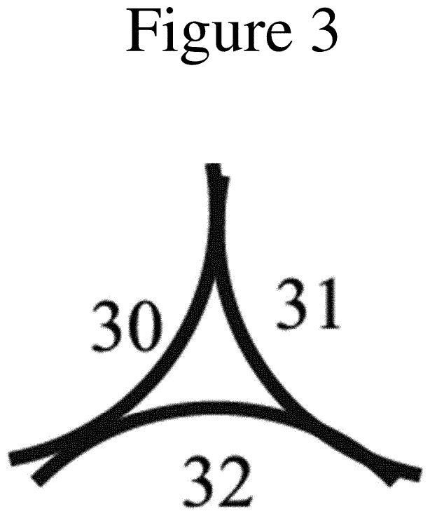

FIG. 3 shows a variation of the heave structure with a concave surface. An important point is that the heave structure does not have to be tabular. Because the other heave structures shown for this invention and other heave inventions of prior art have a flat or convex surface, efficiency can be lost by water sliding over them. A cupped and concave surface is likely to be more efficient and capture more energy. Elements (30,31,32) show one embodiment of that. The tabular or polyhedral structure of whatever shape can have variable thickness. We have found that such variation can be associated with different efficiencies.

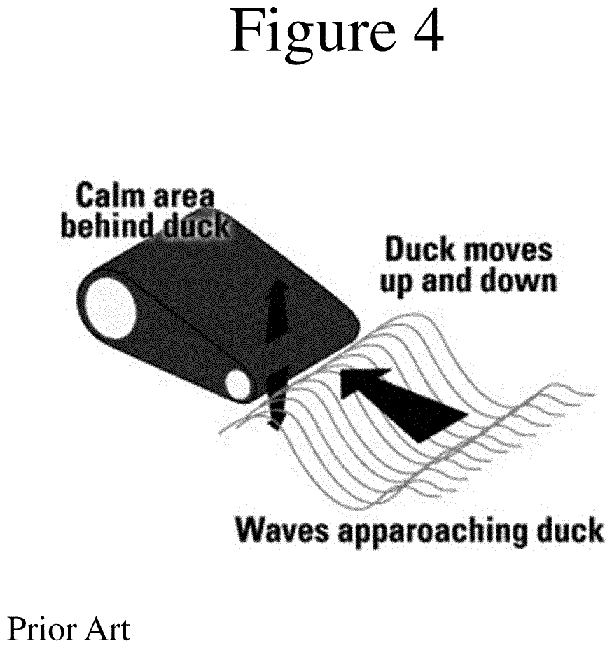

FIG. 4 is an illustration of how a Salter's Duck turbine works.

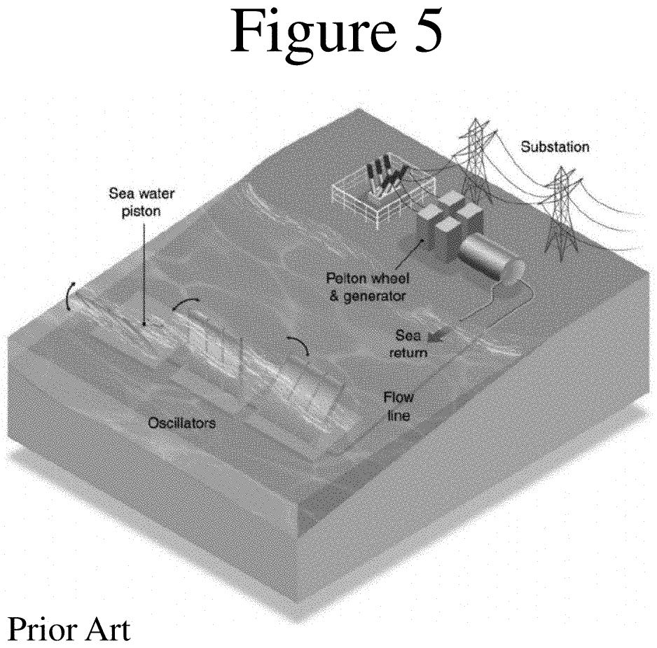

FIG. 5 illustrates an oscillating system.

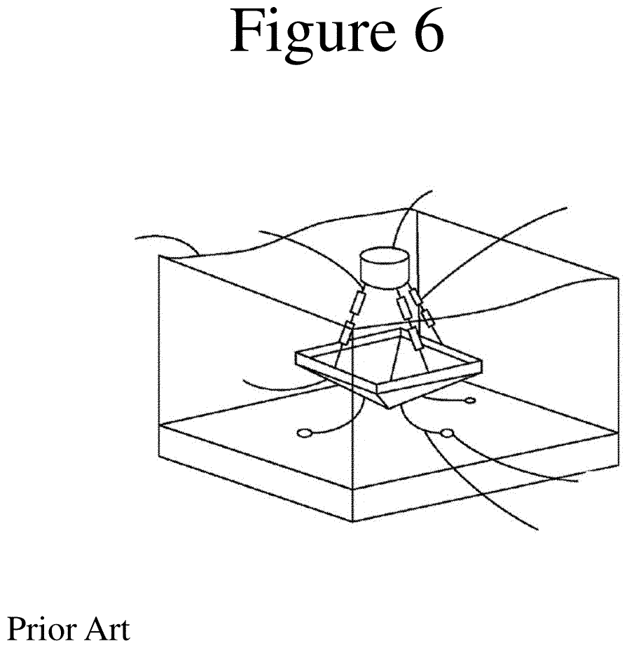

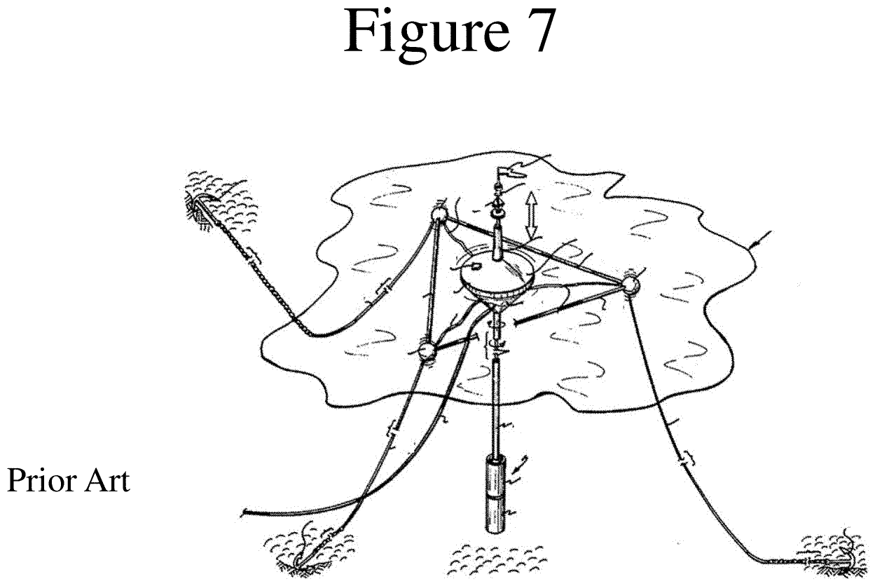

FIG. 6 illustrates a buoy system. FIG. 7 illustrates another buoy system. The limitation of a buoy system is that it moves only up and down and misses the rolling force of the waves.

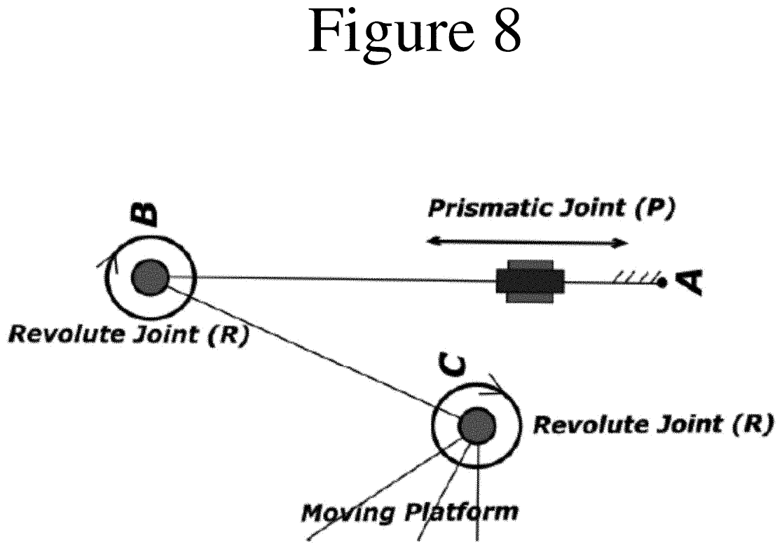

FIG. 8 illustrates the definition of the joints.

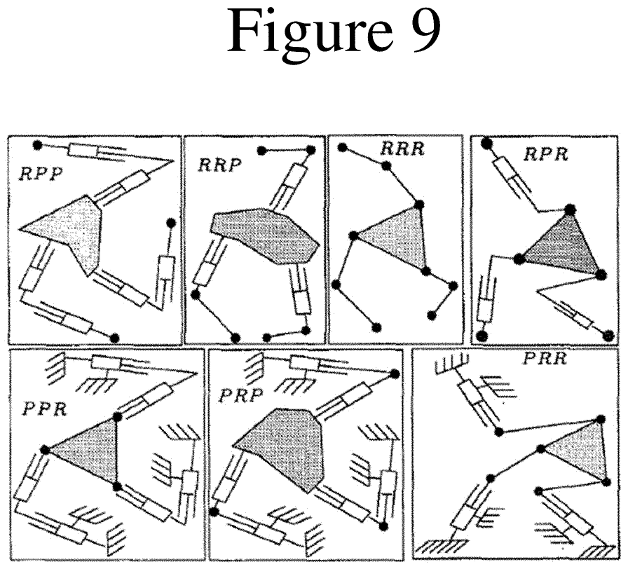

FIG. 9 shows the variety of combinations of joints to make a three-degree-of-freedom device. It illustrates the common abbreviations of the likely combinations. One can see the flexibility of these different configurations in terms of being able to respond to the non-linear motion of waves.

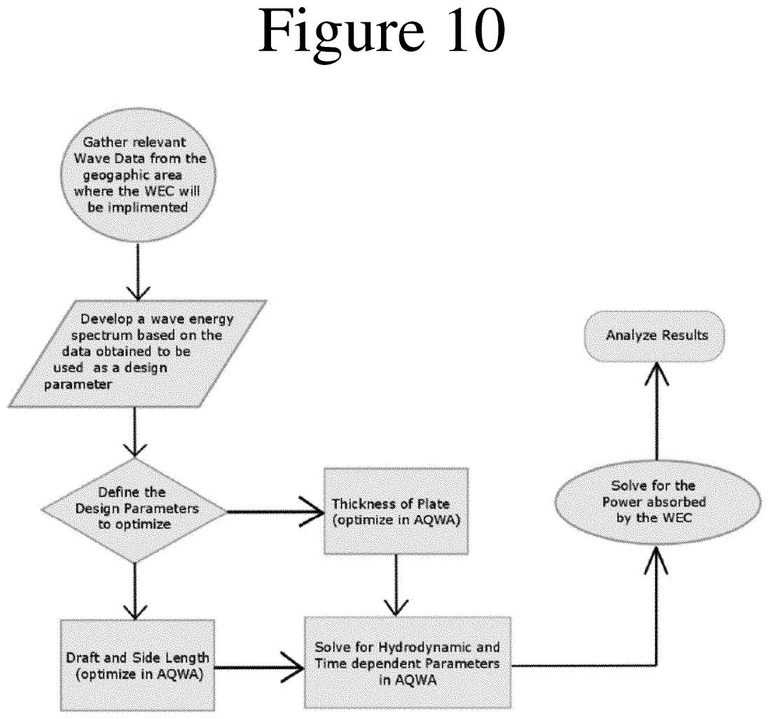

FIG. 10 shows the process of customizing the concept for a particular site in the ocean. This involves obtaining data on the average, median, and mode of a particular location, using that information to decide on a standard wave height to use as the basis to design a project, and picking a design point for the system, which will usually be double the standard wave height so that one can cover the ranges from zero to a large majority of the wave heights. Alternatively, one may use this distribution to maximize energy obtained by choosing a point higher than the standard wave height for the design of the system if there are a lot of higher waves in that location. Since power is proportional to wave height squared, there is more to be gained in terms of total power by capturing the higher end of the spectrum, depending on the total cost-effectiveness of making a higher capacity turbine. In some circumstances, moderate amounts of power delivered consistently are more the desires of the customer, in which case the best choice is to double the standard wave height in determining maximum height of the upper structure.

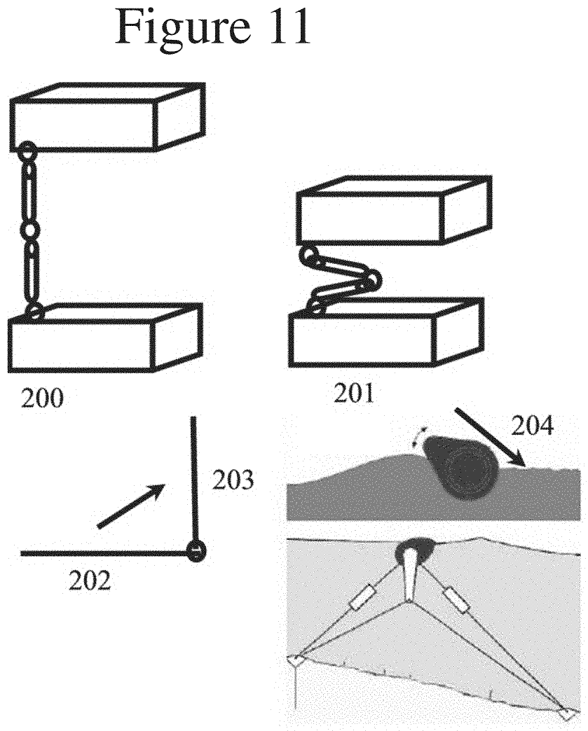

FIG. 11 illustrates how the current invention compares with other technologies. The potential advantage of this is not only an increase in efficiency for a particular wave, but it addresses a limitation of heave devices—that they are efficient for a particular wave height but cannot “stretch” to change the wave height they can adjust to. A current-art heave converter that was made to work on 1-meter high waves will always be limited to 1 meter of a 2-meter wave, but the current invention can be made so it can bend according to a range of wave heights. If it is 1 meter when the joints are bent at 45 degrees, it can become 2 meters when the joints are at 90 degrees to the base structure. This variation is a normal feature of waves. Currently, a project developer might measure that 1-meter waves are the average in a location, and use a converter made for ideal performance for 1-meter waves. With the current invention, a developer can determine, for example, that the average waves are 1 meter but 90% of the time they vary from 0 to 3. Then the developer would order from the applicant a 3 points of freedom wave harvester whose maximum height is 3 meters, but which can bend to nearly zero.

In FIG. 11, assume a wave is coming from the left. Configuration (200) shows the current invention fully stretched up; (201) shows it at minimal height. This means it can handle a range of wave heights with equivalent efficiency. The Salter's duck, the archetypal heave device, has a single fixed height (204) and that is its optimal efficiency. The base plate of a clapper (202) is attached via a joint to a movable upper plate (203) in a common configuration for many types of wave turbines. Any variation of wave height over the ideal it was built for will add nothing to the energy harvesting. In addition, the joints allow the current invention to move with the waves and capture more of their motion.

Clearly, the base plate needs to be fixed at the time that the heave plate is moving. However, its height from the sea floor can be adjustable. There are many reasons to adjust it, such as taking advantage of higher waves, adjusting to differences in surface height during tides, or purposely submerging it during dangerous storms.

The current invention can transfer the energy from the wave converter into useful electrical energy in at least three ways, each of which is prior art:

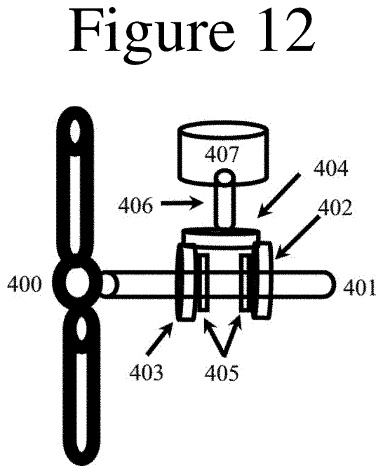

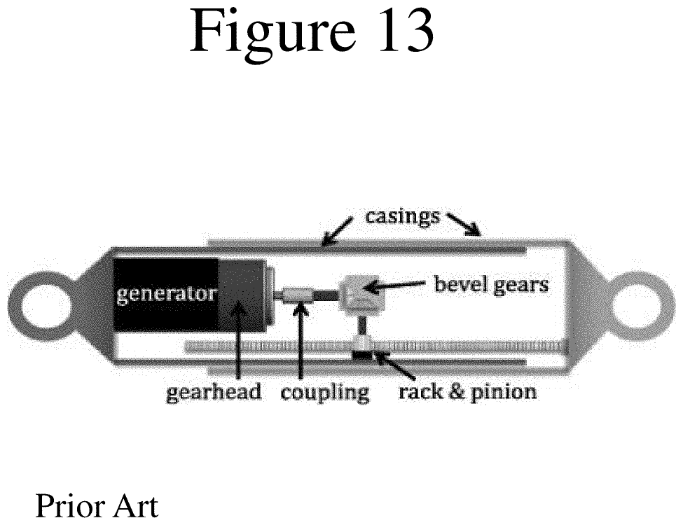

1. Gyroscopes. This is the method of Salter's Duck.
The current application is a heave mechanism, in the same family as the Salter duck. The methods of obtaining energy from the Salter duck have already been specified clearly in his patents and are enabling for anyone wishing to use the same system.
2. Typical permanent magnet generators at each joint. Since each joint moves back and forth, it is advantageous to change that back and forth motion into unidirectional motion. One way to do that is to use a combination of clutches and bevel gears. FIG. 12 is an illustration of a bevel-clutch device. FIG. 13 is an illustration of its use with a rack and pinion device.
3. Hydraulics. At each rotation or “prismatic” motion of the arms, they can push against hydraulic fluid, which then drives a generator.

An older method of using hydraulics is the Cockrell's Raft, referred to in patent GB1,448,204, uses a similar concept. It states in the abstract from that patent: “Apparatus for extracting energy from the wave movement of the sea comprises two or more buoyant members 11 which are hinged one to another, the members together defining a substantially continuous lower surface, and means connected between each two buoyant members for converting relative movement of the members into useful energy. As shown, the means connected between each two buoyant members comprises a hydraulic or pneumatic device 12 which transmits pressure pulses to means such as a reservoir (not shown). The apparatus can be positioned off shore and can be used to pump water to a reservoir which can be used for powering a shore based hydro-electric installation.”

FIG. 12 shows how a clutch and bevel gear device can capture motion in two directions and transform it into more efficient unidirectional motion. This is known art. A revolute joint (400) is attached to a shaft (401). Bevel gears (402, 403, 404) assisted by clutches (405) enable a shaft (406) attached to a generator (407) to rotate in one direction so that no momentum is lost as the joint moves from side to side.

FIG. 13, also known art, is a picture of how bevel gears can be used instead with a rack and pinion in order to create unidirectional motion for a generator. This can be combined with a prismatic joint. Element 300 is an arm that moves with wave motion. It pushes against a device holding hydraulic fluid (301) and increases its pressure. In one embodiment, it pushes against a second side or separate device (302) as it moves the opposite way and increases the pressure.

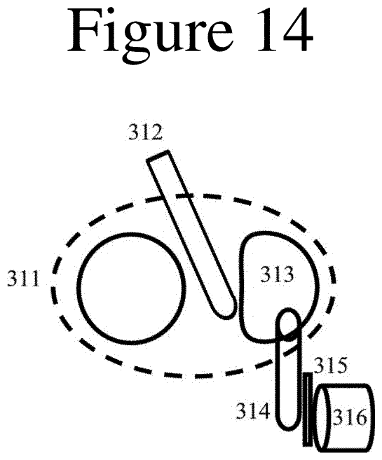

FIG. 14 shows how the back and forth motion in a revolute joint (311) can cause the arm (312) to push on a container of air (313), compress it, direct it into a tube (314), and then spin a structure (315) and drive a generator (316).

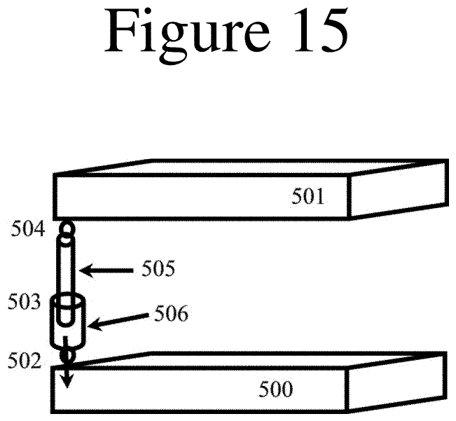

FIG. 15 is a picture of how the hydraulics could work in a prismatic joint. Base structure (500) is attached to heave structure (501). In this example, the arm device consists of revolute joints (502, 504) and a prismatic joint. The arm (505) compresses fluid in (506) and pushes it into the base, in one embodiment through a tube, where it can turn a generator, as shown previously.

While the invention has been described with respect to a limited number of embodiments, it will be appreciated that many variations, modifications and other applications of the invention may be made.

What is claimed is:

1. A system for obtaining energy from a wave in a body of water, comprising:
a base structure, with at least two sides, fixed to a base in or adjacent to waves,
a floating heave structure, with at least two sides, said heave structure substantially submerged by the water,
at least two arm devices, each arm device comprising:
a base joint of either a prismatic P type or a revolute R type attached to a side of the base structure facing the heave structure,
a heave joint of either the prismatic P type or the revolute R type attached to a side of the heave structure facing the base structure, said heave joint corresponding substantially to positions of the base joints on the base structure,
each said base joint is substantially aligned vertically with each said heave joint, said alignment termed to constitute a pair,
each base joint is attached to a base arm,
each heave joint is attached to a heave arm,
each vertically aligned pair of base and heave arms with their respective joints is attached to a middle joint of either the prismatic P or revolute R types;
each said arm device may be arranged in the following joint sequences, wherein the base joint is mentioned first as R for resolute or P for prismatic, the middle joint is mentioned second, and the heave joint is mentioned third: RRR, RRP, RPP, PRR, PRP, PPR,
each said arm device is connected to at least one generator system, said generator system defined as any mechanism, such as hydraulic or electrical, that results in energy production from the motion of the arm device,
each system comprises exactly 3 arm devices,
at least one joint is connected to a generating system, optionally a gyroscope, a hydraulic take off device, or a device including bevel gears for creating unidirectional motion attached to a generator.

2. The system of claim 1, wherein at least one said generator system comprises a hydraulic mechanism containing a compressible fluid, said fluid compressed by the motion of the arms and joints.

3. The system of claim 1, wherein at least one arm device comprises an electric generator, operating from rotational motion of any of the arm's revolute joints.

4. The system of claim 1, wherein the base structure is below the heave structure.

5. The system of claim 4, wherein the base structure is between an upper part of the wave on the surface and a lower part of the wave, beneath the surface.

6. The system of claim 1, wherein the base structure is adjustable in height above a sea floor of the body of water while fixed to a supporting object.

7. The system of claim 6, wherein a second heave structure is attached by said three arm devices to a second side of the base structure.

8. The system of claim 1, wherein the heave structure is substantially planar.

9. The system of claim 1, wherein the heave structure is a polygonal structure

10. The system of claim 1, wherein at least one part of the heave structure is concavely cupped in an area of impact of the wave on the heave structure,

11. The system of claim 1, wherein a length of the heave structure is equal to or a little greater than a wavelength of the wave.

12. The system of claim 1, wherein the heave structure is at least partially hollow.

13. A method for constructing a system to harvest energy from a wave in a body of water, comprising:
providing a base structure, with at least two sides, fixed to a base in or adjacent to waves,
providing a floating heave structure, with at least two sides,
providing at least two arm devices, each arm device comprising:
a base joint of either a prismatic or a revolute type attached to a side of the base structure facing the heave structure,
a heave joint of either the prismatic P type or the revolute R types attached to a side of the heave structure facing the base structure, said heave joint corresponding substantially vertically to a position of the base joint on the base structure, said alignment termed to constitute a pair,
each said base joint is attached to a base arm,
each said heave joint is attached to a heave arm,
each vertically aligned pair of base and heave arms and their respective joints is attached to a middle joint;
each arm device is connected to at least one generator system, said generator system defined as any mechanism, such as hydraulic or electrical, that results in energy production, from the motion of the arm device,
at least one joint is connected to a generating system, optionally a gyroscope, a hydraulic take off device, or a device including bevel gears for creating unidirectional motion attached to a generator.

14. The method of claim 13, comprising at least 3 arm devices.

15. The method of claim 13, during an initial construction of the system in the process of project design, further comprising:
obtaining data comprising height of waves in a particular location over time,
determining a standard wave height, based on one of a group of average, median, or mode of the wave heights in a designated area,
setting the fully extended height of the arm devices for said location as at least double the standard wave height.
